(19) United States
(12) Patent Application Publication
(10) Pub. No.: US 2009/0000126 A1
(43) Pub. Date: Jan. 1, 2009

(54) Electrically Operated Shaver

(76) Inventor: Bernhard Kraus, Braunfels (DE)

Correspondence Address: FISH & RICHARDSON PC, P.O. BOX 1022, MINNEAPOLIS, MN, 55440-1022, US

(21) Appl. No.: 12/185,346

(22) Filed: Aug. 4, 2008

Related U.S. Application Data
(63) Continuation of application No. PCT/EP2006/012034, filed on Dec. 14, 2006.

(30) Foreign Application Priority Data
Feb. 2, 2006 (DE) 10 2006 004 675.7

(51) Int. Cl. B26B 19/00; B26B 19/20; B26B 19/28

(52) U.S. Cl. 30/34.1; 30/43; 30/45

(57) ABSTRACT

An electrically operated shaver includes a shaver housing and a cutter head. The cutter head is arranged on the shaver housing and includes at least one cutting device comprised of an outer cutter equipped with apertures and an under cutter. The cutters are driven into sliding relationship to one another by an electric drive, so that hairs entering the apertures are cut off by the cutting device. Provided on the cutter head adjacent to the cutting device is a supporting element which, like the cutting device, is engaged by an operator's skin surface during a shaving operation. Both the cutting device and the supporting element are mounted in the cutter head for displacement against the force of a spring. Means are provided for enabling a different distribution of the contact forces (F1, F2) to the cutting device and the supporting element.

### CROSS-REFERENCE TO RELATED APPLICATIONS

This application is a continuation of, and claims priority under 35 U.S.C. 120 from, International Application No. PCT/EP2006/012034, filed Dec. 14, 2006, which claims priority to German Application No. 10 2006 004 675.7, filed Feb. 2, 2006. The contents of each of these applications are incorporated herein by reference in their entirety.

### TECHNICAL FIELD

This invention relates to an electrically operated shaver.

### BACKGROUND

From U.S. Pat. No. 5,398,412 there is already known an electrically operated shaver in which the cutter head is mounted on an upper end of a shaver housing. The cutter head mounts a head frame to which two outer cutting devices are fastened. Two inner cutting devices are forced by means of a respective biasing spring into contact with the outer cutting devices and are driven to reciprocate relative to the outer cutting devices in an oscillating fashion for shaving or shearing off the hairs. The outer cutting devices can be made to engage different areas of a user's skin in order to enable a more effective shave to be accomplished.

The head frame is floatingly supported on the cutter head so that the outer and inner cutting devices are depressed together with it under compression of the springs. The biasing forces of the springs are thereby increased when the head frame is depressed. When a user wishes to shave hard hairs the head frame is depressed more firmly so that the biasing force, i.e., the contact pressure between the outer and inner cutting devices, is increased. This enables hard hairs to be cut off or sheared off successfully with an increased contact pressure. The more deeply the head frame is depressed for increased contact pressure, the more counterpressure is applied to the skin by the outer cutting devices.

Counterpressure is an absolute requirement for shaving, but it should be held within a tolerated range because too high a counterpressure may irritate the skin. This is due to the fact that the skin then penetrates too deeply into the apertures of the outer cutting devices, meaning the outer cutters, and the inner cutting devices, namely preferably two cutter blocks, may injure the skin. However, when hard hairs are shaved with the floatingly supported head frame of the above-named patent, it is necessary for the head frame to be depressed deeply, which results in an increased counterpressure. In other words, shaving hard hairs does not become possible until after the head frame has been depressed far and deep into the cutter head, however at the expense of an increased counterpressure. Soft hairs, by contrast, can be shaved nearly without depressing the head frame and therefore in the presence of only a light counterpressure on the skin.

From DE 600 02 040 T2 there is furthermore known a shaver which is in a position to be depressed uniformly at different positions, but at different contact pressures between the outer and the inner cutting devices. In this arrangement, the inner cutting devices which are formed by two cutter blocks extending side-by-side are set in oscillatory motion by an electrically powered motor, so that their cutting or shearing contact with the outer cutting devices, which in this arrangement are formed by shaving foils arcuately curved in an upward direction, enables the hairs to be sheared or cut off. The inner cutting devices are urged upwardly by a biasing spring, causing a contact pressure to be produced on the undersides of the shaving foils, with which the inner cutting devices are urged into engagement with the outer cutting devices.

The outer cutting devices are carried by a cutting device holder which is movably held on a head frame mounted on the upper end of the housing. The shaver accommodates a level control mechanism for controlling the level of the head frame relative to the housing between a high or top position and a low or bottom position, while the biasing springs are compressed a greater or lesser degree in order to vary the contact pressure and to enable the cutting device holder to be depressed relative to the head frame in both the top and the bottom position. In addition to the fact that therefore the outer cutting devices can also be depressed in the bottom position when hard hairs are shaved, the shaving of hard hairs is made possible in the bottom position in which the increased contact pressure is available. In this process, however, the outer cutting devices are not held compressed relative to the head frame and accordingly no increased counterpressure is exerted on the skin, whereby the shaving of hard hairs can be accomplished successfully with an increased contact pressure but without irritation of the skin.

In other words, the increased contact pressure effective for shaving hard hairs can be originally adjusted without depressing the outer cutting devices which would otherwise increase the counterpressure on the skin. By contrast, shaving of soft hairs can be performed with a head frame held in the top position, thereby enabling the outer cutting devices to follow the contour of the skin but with a reduced counterpressure on the skin.

Moreover, DE 102 46 519 A1 discloses a shaver having a movable cutter head with at least one cutting device for the removal of hairs on a skin surface. The particularity of the invention is that provision is made for a detection device for detecting a variable which is related to the position of the cutting device relative to the skin surface. Furthermore, the invention comprises at least one actively actuated actuator arrangement for varying the position of the cutter head and one control device for controlling the actuator arrangement in response to the detected variable. This is intended to ensure at all times an optimum skin contact of each cutting element. A beneficial effect is expected in particular when the shaver includes two or more cutting devices which, for optimum hair removal, are to make simultaneous contact with an operator's skin surface.

### SUMMARY

In one aspect, an electrically operated shaver includes an electric drive, a shaver housing, and a cutter head arranged on the shaver housing. The cutter head includes a support and a cutting device adjacent the support. The cutting device includes an outer cutter defining apertures for accepting hairs, and an under cutter. The outer cutter and the under cutter are movable relative to each other by the electric drive, such that hairs entering the apertures are cut off by the cutting device. The supporting element and the cutting device are each engaged by a user's skin surface during a shaving operation in which each bears a respective skin contact load, and the cutter head is configured to alter a skin contact force distribution between the cutter assembly and the support.

A means for altering a skin contact force distribution between the cutter assembly and the support enables a different distribution of the contact forces acting on the cutting device and the supporting element to be accomplished, so that the outer cutter can be provided with maximum possible apertures while at the same time a thin foil is used. As a result, hairs are readily threaded into the larger apertures of the shaving foil, and a thorough shave is accomplished even when the outer cutter engages the skin surface with a low contact pressure. To prevent the skin surface from being pressed too deeply into the apertures of the outer cutter when an increased contact pressure is applied, the shaver provides for variation of the contact pressure of the outer cutter against the skin surface. This is not accomplished by attempting to influence the force with which the user presses the shaver against the skin, but rather, this contact force is split into a force acting on the above-named outer cutter, which is a shaving foil as a rule, and a force acting on a second supporting element. The result is an improved shaver performance with minimum irritation to the skin. In this arrangement, it is advantageous for both the cutting device and the supporting element to be mounted in the cutter head for movement against the force of a spring.

Some implementations feature variously selected spring biases of the springs on the cutting device and the supporting element, with the spring bias on the cutting device being greater than the spring bias on the supporting element. In this arrangement, the aperture geometry of the cutting device can be selected such that until the spring bias on the cutting device is overcome, the latter is urged against the skin surface, whilst the supporting element practically performs no supporting work until this value is reached. In this way, the shearing performance on the cutting device is optimized, whereas, after the spring bias on the cutting device is overcome, the supporting element takes a greater share of the contact load whereby the penetration depth of the skin into the apertures of the cutting device is slowed down, being thereby held within limits.

In some implementations, the spring constant for the cutting device is smaller than the spring constant for the supporting element. In consequence, the more firmly the shaver is urged against the skin surface, the more the cutting device and the supporting element have to take support on their springs. Owing to the different spring constants, however, the supporting element offers a greater resistance than the cutting device and therefore takes a greater share of the contact load. This results advantageously in a limited penetration depth of the skin into the apertures of the outer cutter of the cutting device, so that the skin is treated more gently. Initially however, the cutting device is urged against the skin more strongly, but only to a degree which is still tolerable for the skin. Because of the initial higher support of the contact force on the cutting device as against the supporting element, the cutting device is initially pressed against the skin more strongly, which has a significant beneficial effect on the cutting operation. The more strongly the skin presses against the cutting device, the greater the force component transmitted to the supporting element, so that the skin penetration depth of the cutting device no longer experiences a notable increase.

In some implementations, the provision of more than two cutting devices on the cutter head may well be contemplated, in which event the pair of like aperture geometry is in adjacent relationship to each other. As a result, those cutting devices are invariably in side-by-side arrangement that are provided with the same spring force and accordingly are also able to retract uniformly when a force is applied. These then also perform the same supporting work relative to the cutting device or the other cutting devices, which has a beneficial effect also on the cutting performance.

In some implementations, the cutter head is pivotal additionally about a fulcrum so that, regardless of the different retraction of the cutting device and the supporting element or second cutting device, the contact forces F1, F2 can be influenced by the degree of pivotal motion of the cutter head. This solution relates in particular to a shaver of the “Braun Synchro” type as initially mentioned, for example. However, if the cutter head is not pivotally mounted but stationary in the shaver housing, then only the cutting device or the supporting element in the cutter head are displaceable.

In some implementations, added provision is made for displaceability of the fulcrum of the cutting devices in the cutter head itself, whereby account can be taken of the fact that when operators tend to urge the shaver against the skin surface with an increased force, the cutter head is pivoted in such a way that an increased contact load is taken by the cutting device with the smaller apertures. In cases where operators tend to press the shaver against the skin surface with a diminished force, the fulcrum in the cutter head can be shifted in such a way that the cutting device with the larger apertures takes up a greater share of the contact load, which naturally has an effect on an increased penetration depth of the skin into the larger apertures.

In some implementations, on sideways displacement of the fulcrum on the cutter head, the ratio of the two contact forces acting on the outer cutter and the under cutter is approximately reciprocal to the ratio of the two distances of the outer cutter and the under cutter relative to the fulcrum.

While some features allow for a purely mechanical control of the magnitude of the contact forces against the cutting devices, other features allow for control of the contact forces against the cutting devices and the supporting element against the skin surface by electrical/electronic means. Serving this purpose are at least one sensor provided on the cutter head as well as an electrical actuator arrangement and a microcontroller which captures the data from the force sensor, evaluates them in accordance with a predetermined pattern and subsequently controls the actuator arrangement with electrical signals, such that a pivoting motion of the cutter head results in the cutting device being exposed to a contact pressure that is held within limits. By pivoting the cutter head, the force application can be transferred more or less to the supporting element, so that for a good shaving result the skin does not penetrate all too deeply into the apertures of the cutting device.

Advantageously, the actuator arrangement through which the cutter head pivotally mounted on the shaver housing is pivoted is provided on the shaver housing. For this purpose it is advantageous if the motor driving the cutting device is received in the cutter head itself. The cutter head is then pivotally mounted only on the shaver housing, and the motor, which is preferably constructed as a linear motor, is connected to the electric supply in the shaver housing via flexible current leads. The coupling device between the control motor and the cutter head may comprise, for example, a toothed belt arrangement or a transmission arrangement consisting of gears which produces the pivotal motion of the cutter head.

Preferably, the sensor may be a force sensor on the cutting device which delivers measurement data to serve as a measure of the penetration depth of the skin surface into the outer cutter. It will be understood, of course, that a measuring device would also be possible which measures directly the penetration depth of the skin into the apertures of the shaving foil, for example, an optical or a radiation sensor device, but the measure of the contact pressure or the contact force onto the cutting device provides likewise a good indication of the penetration depth of the skin into the apertures if the penetration depth has been previously measured under laboratory test conditions with a given aperture geometry of a shaving foil in dependence upon accurately defined contact forces.

A highly practicable solution results with a force sensor, which comprises a magnet mounted on the cutting device on the one hand, and a Hall probe mounted on the cutter head on the other hand, said Hall probe converting the distance traveled by the magnet into electrical signals which are used as a measure of the magnitude of the contact force.

In some cases, the electronic pressure control solution is particularly advantageous if also the supporting element is formed by a cutting device which in its embodiment essentially corresponds to the first cutting device, but by contrast exhibits a smaller aperture geometry and at least one spring which has a smaller spring bias than the first cutting device. The electronic control of the contact forces is superimposed upon the mechanical control by means of the spring forces, thus enabling the control to even better respond to increased contact forces without the added need for operator intervention. The decisive advantage is also here that in the presence of low contact forces the cutting device with the larger apertures performs the major part of the cutting work without the skin entering the larger apertures all too deeply.

It is an advantage also in this system when the pair of cutting devices with like aperture geometry is always arranged side-by-side.

A sideways displacement of the fulcrum on the cutter head changes again the torques acting on the cutter head due to the changing contact forces, so that this also enables the basic setting of a shaver to be varied within narrow limits. Operators with a more robust skin shift the fulcrum of FIGS. 4 and 5 more to the right, so that the cutting device with the larger apertures comes to bear more. Operators with a softer skin take the other direction.

In some implementations, provision is made on the shaver for another sensor which measures the shaver speed. The higher the shaver speed, the smaller the amount of skin able to penetrate into the larger apertures of the first cutting device, and the later the need for the cutter head to be pivoted to take the load from the first cutting device.

As a sensor for the shaver speed, an optical sensor=has proven to be advantageous, which is constructed identical to the optical sensor of a computer mouse. A more detailed description is therefore dispensed with.

In addition to and in lieu of the speed sensor, it is also possible to use on the cutter head a sensor which measures the moisture of an operator's skin surface, which sensor likewise supplies data to the electronic control device, with the ultimate effect that in the presence of a particularly moist skin the contact force against the cutting device with the larger apertures may be greater than in the presence of a very dry skin. To accomplish this, the two resistances between the shaving foils of the two cutting devices are measured and fed to the microcontroller which then pivots the actuator arrangement and hence the cutter head correspondingly.

In addition to the speed sensor and the skin moisture sensor, the cutter head may also mount a position sensor which detects the position of the shaving foils and likewise provides information about whether soft skin parts—because these tend to be found in the horizontal area—or hard skin parts—because these tend to be found in the cheek area, that is, in the vertical area—are involved. When the predominantly horizontal position is detected, the cutter head is turned so that the cutting device with the larger apertures absorbs less contact force, which reduces the penetration depth of the skin into the apertures. Every one of the above-described individual sensors may be arranged on the shaver singly or in combination with another sensor or even with all of them.

Finally, the shaver may also mount a friction sensor which—similar to the skin moisture sensor—provides likewise indirectly information about the condition of the skin, but which additionally determines the effect of the contact pressure of the cutter head against the skin surface and informs the microcontroller accordingly. The higher the values on the friction sensor, the greater the amount of pivotal motion of the cutter head to the effect that the contact force diminishes on the shaving foil with the larger apertures. Advantageously, the friction sensor is formed by a strain gage which is integrally formed with the shaving foil.

Preferably, a mode switch may be provided on the shaver housing for switching the individual sensors on or off. In addition, the mode switch may also be set to the settings “hard”, “medium” or “soft”, which enables the skin penetration depth into the larger apertures of the first shaving foil to be increased (hard) or decreased (soft).

In some implementations, a method for the controlled distribution of the contact forces acting on a cutting device and a supporting element is also claimed.

Implementations described herein allow thorough hair removal during a shave while protecting the skin to the greatest possible extent.

Several embodiments will be explained in greater detail in the following with reference to the accompanying drawings.

### BRIEF DESCRIPTION OF THE DRAWINGS

FIG. 1 is a view, in longitudinal section, of an electrically operated shaver in which the cutter head mounts two cutting devices arranged side-by-side and displaceable in the cutter head independently of one another;

FIG. 2 is a view, in longitudinal section, of a cutter head shown at the instant of engaging an operator's skin surface during a shaving operation, which cutter head is pivotally mounted via an electrically controllable actuator arrangement on a shaver housing only partially shown;

FIG. 3 is a schematic block diagram for an electrically controllable contact pressure control corresponding to the embodiment of FIG. 2;

FIG. 4 is a view of another embodiment of a cutter head partially shown only in longitudinal section and pivotal in a shaver housing, wherein for adjustment of the contact pressure distribution the fulcrum of the cutter head itself is movably mounted in the cutter head and the fulcrum in this embodiment has just adopted its center position relative to the pivotal head;

FIG. 5 is a scrap view of a cutter head, shown only in part, of FIG. 4, in which how-ever the fulcrum extends no longer centrally to the cutting devices but is displaced more towards the left-hand cutting device in the cutter head; and

FIG. 6 is a schematic part sectional view of another embodiment of a cutting device in which only one spring is responsible both for the biasing force of the under cutter against the outer cutter and for the resilient retraction of outer cutter and under cutter during a shaving operation.

### DETAILED DESCRIPTION

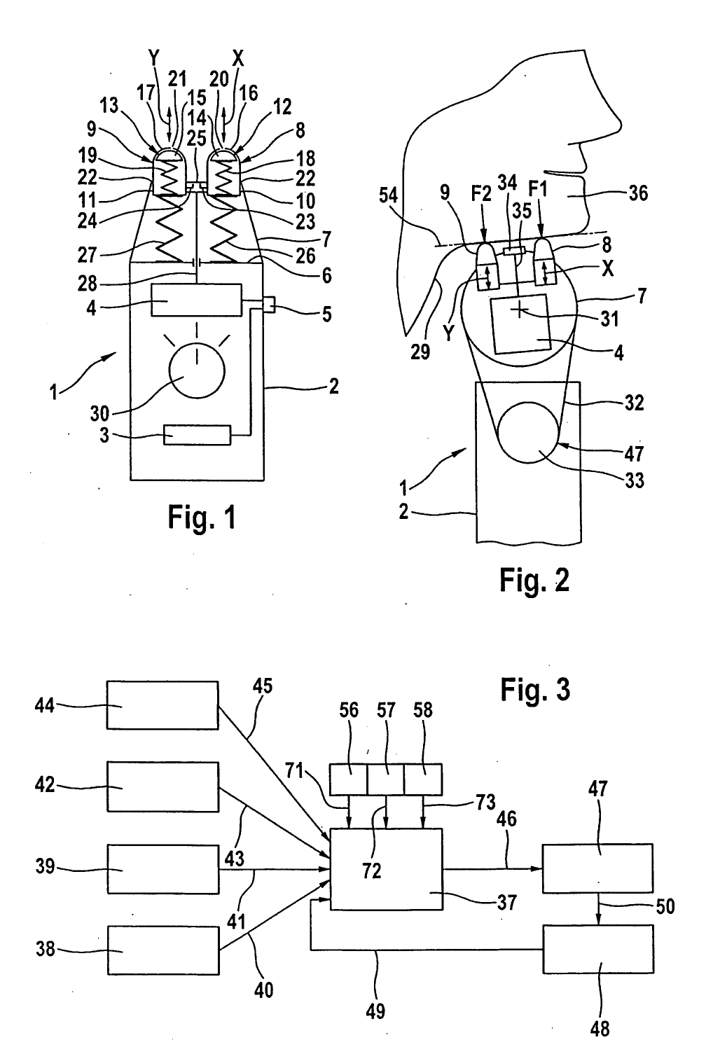

In FIG. 1 the shaver 1 is comprised of a shaver housing 2 mounting in its interior an electric motor 4 which is driven by an electric power source 3, in the present case a rechargeable battery, and is connectable to the electric power source by an electric on/off switch 5. Secured to the upper end 6 of the shaver housing 2 is a cutter head 7 on which at least two cutting devices 8, 9 in side-by-side arrangement are mounted for displacement in the direction of movement X and Y, respectively, towards and away from the shaver housing 2.

In the embodiments of FIGS. 1, 2, 4 and 5 the cutting devices 8, 9 are comprised essentially of a respective housing portion 10, 11 accommodating each one inner cutting device 12, 13. The inner cutting devices 12, 13 are each comprised of a cutter block on which individual blades 14, 15 are fastened one behind the other. The blades 14, 15 have their shearing surfaces in engagement with the undersides of the outer cutters 16, 17 bounding the blades 14, 15 from outside. In FIG. 1, however, the spaces between the blades 14, 15 and the outer cutters 16, 17 are low for greater clarity of illustration of these parts. The outer cutters 16, 17 are shaped in an upwardly arched configuration and extend parallel at right angles into the plane of projection. The same applies to the under cutters 12, 13. On a very firm skin surface 29, a tangent applied to the outer cutters 16, 17 forms the cutting plane 54 for the shaver 1.

The cutter blocks 12, 13 are urged against the undersides of the outer cutters 16, 17 by biased springs 18, 19. The outer cutters 16, 17 have a plurality of small apertures 20, 21 of which only one aperture 20, 21 is shown by way of example in the outer cutters 16, 17 in a larger cross-section. In FIG. 1 the upper side of the cutter head 7 includes openings 22 which are shaped to conform with the cross-sections of the housing portions 10, 11 flush-mounted therein and in which they are upwardly and downwardly slidable in accordance with the directions of movement X and Y. Formed on the housing portions 10, 11 are stops 23, 24 which limit the movement of the cutting devices 8, 9 in upward direction when they strike against the upper side 25 of the cutter head 7 from below. Bearing against the undersides of the housing portions 10, 11 are springs 26, 27 which with their other ends take support on a wall 6 on the cutter head 7. In FIG. 1, the wall 6 represents both the wall of the cutter head 7 and the wall of the shaver housing 2. The springs 26, 27 urge the cutting devices 8, 9 so far upwardly until their stops 23, 24 strike against the upper side 25. In FIG. 1 the springs 18, 19 serve primarily the purpose of biasing the under cutters 12, 13 against the undersides of the outer cutters 16, 17. The springs 26, 27 of FIG. 1 are responsible for the retraction and the distribution of forces to both cutting devices, which will be explained later in greater detail as the description proceeds.

The electric motor 4 is connected to the cutter blocks 12, 13 through a mechanical transmission device 28 and causes them to oscillate rapidly in a reciprocating motion, so that the blades 14, 15 produce a shearing motion on the apertures 20, 21 of the outer cutters 16, 17, thereby shearing or cutting off hairs entering the apertures 20, 21 during a shaving operation.

In lieu of the two springs 18, 26 and, respectively 19, 27 bearing against the cutting devices 8, 9, it is also possible to use only one spring 18, 19, as becomes apparent from FIG. 6. In this case the springs 26, 27 are in charge not only of urging the cutter blocks 12, 13 against the outer cutters 16, 17 but also of retracting the cutting devices 8, 9 in the presence of contact forces F1, F2 acting from outside. In FIG. 6 only the right-hand cutting device 8 (FIG. 1) acted upon by force F1 is shown. Such a shaver arrangement including two cutting devices 8, 9 and one center cutter separating them is known, for example, from the “Braun Synchro 7650” shaver.

In this type of shaver the two cutter blocks 12, 13 of which only the right-hand cutter block 12 is shown in FIG. 6 are spring-mounted on a base 61 independently of each other in the direction of movement X and Y, respectively, against the force of a spring 26, 27. In the following, reference will be made only to the one cutting device 8 illustrated in FIG. 6, since, except for the biasing force and the spring constant of the spring 27 and the aperture geometry of the outer cutter 17, the second cutting device 9 is otherwise identical.

Extending from the underside of the cutter block 12 in downward direction is a guide bar 64 which passes through a bore 65 in the base 61 and has at its end an enlarged portion 66 rearwardly embracing the bore. Owing to the biasing force of the spring 26, the guide bar bears with one end against the underside of the cutter block 12 and with its other end against the upper side 67 of the base 61 so that the cutter block 12 is biased into flush engagement with the underside of the outer cutter 16 which in the present case is a very thin shaving foil. The base 61 and hence the cutter block 12 is clipped onto the drive shaft 62 of the drive motor 4 in a firm and clearance-free relationship. The outer cutter 16 is mounted for displacement in the direction of movement X in a removable frame 63 which in turn is detachably mounted in the cutter head 7. The removable frame 63 has on either side of the under cutter 12 guiding devices 69 for guiding the end sections of the outer cutter 16 in the direction of movement X. Formed on the end sections of the outer cutter 16 are stops 70 for limiting the direction of movement X in the removable frame 63.

In lieu of the cutter system in the form of cutter blocks 12, 13 sliding in a reciprocating motion along outer cutters 16, 17 as shown in FIGS. 1, 2 and 4 to 6, it is of course possible to use a cutter system in the form of rotary cutting devices which include respective rotary under cutters biased into sliding engagement with the undersides of two apertured outer cutters in side-by-side arrangement, so that hairs are cut off when they enter the apertures of the outer cutter, reaching the bite of the under cutter. It is important in this context that each single cutting device lower itself downwardly into the cutter head on the application of a contact force F1 and F2, respectively, after the biasing force is overcome, with the apertures in the cutting device exposed to contact force F1 being larger than those in the cutting device exposed to force F2.

In FIGS. 1 and 2 the springs 26, 27 are biased between the upper end 6 and the housing portions 10, 11 with a predetermined spring bias and also have different spring constants. In FIG. 1, for example, the apertures 20 of the shaving foil 16 are larger than the apertures 21 of the shaving foil 17. In this embodiment, the spring 26 assigned to the housing portion 10 was selected such that the cutting device 8 does not retract until after a force F1 acts on the outer cutter 16. This force F1 is greater than the force F2 acting on the cutting device 9, and the spring constant of spring 26 is then smaller than the spring constant of spring 27.

In a preferred embodiment, the spring 26 recedes from a force of 3 Newton, with a spring constant of 0.5 Newton per mm (N/mm). The spring 27, by contrast, recedes already at a contact force of 0 Newton, but then with a spring constant of 2 Newton per mm (N/mm). It is thereby made possible to provide the shaving foil 16 with apertures 20 as large as possible while at the same time making the foil very thin. As is known, hairs enter more readily into large apertures 20 than into small apertures 21. At the same time, large apertures 20 necessitate a lower contact force of the skin surface 29 against the outer cutter 16 (shaving foil), which is however only possible if the excess force is transferred to the supporting element or second cutting device 9 because of its ability to absorb a higher contact force F2 since the outer cutter 17 has smaller cross-sections on the apertures 21. In this way, a more thorough and gentler shave than with conventional shavers can be accomplished in the same period of time.

FIG. 1 also shows a mechanical switch 30 for inhibiting the movement of both cutting devices 8, 9. This switch 30 affords the added function of varying the biasing forces of the springs 26, 27, thereby enabling the cutting devices 8, 9 to be lowered at an earlier or later instant of time. This is advantageous particularly when persons use too much pressure against the skin surface 29. Depending on the setting of the switch 30 the shaver 1 operates more or less responsively.

FIG. 2 shows a shaver 1 only in part and only in a very simplified representation. In contrast to FIG. 1, the cutter head 7 is pivotal about a fulcrum 31 which extends in the longitudinal direction of the cutting devices 8, 9—that is, perpendicularly into the plane of projection. To avoid duplicate description, only the differences to FIG. 1 will be dealt with in FIG. 2. Correspondingly like parts are therefore not discussed further.

In contrast to the shaver of FIG. 1, the electric drive motor 4 is not mounted in the shaver housing 2 but in the cutter head 7, and the cutter head 7 is pivotal about a fulcrum 31 via a drive belt 32 or some other transmission device, with the drive belt 32 being connected to a drive shaft 33 mounted in the shaver housing 2 on a drive motor. The outer surfaces of the shaving foils 8, 9 slide along a skin surface 29 on the underside of the chin of an operator's head 36. Additionally provided on the cutter head 7 between the two cutting devices 8, 9 is a center cutter 34 connected to the electric motor 4 via a transmission device 35. Advantageously, the electric motor 4 is a linear motor because it can be built to particularly small dimensions and therefore enables easy integration in a comparatively small cutter head 7. A gear arrangement or a generally known pivoting device may also be substituted for the drive mechanism 32, 33 shown in a very simplified representation, provided only that the cutter head 7 can be pivoted at very short intervals about its fulcrum 31 a greater or lesser amount in dependence upon predetermined variables to be identified later as the description proceeds.

FIG. 3 shows a schematic block diagram of an electronic contact pressure control for the shaver of FIG. 2. Its principal item is a microcontroller 37 in which electric pulses are received, processed and passed on. For this purpose, two contact pressure sensors 38, 39 are provided of which for example the contact pressure sensor 38 measures the contact pressure F1 on the cutting device 8, and the contact pressure sensor 39 measures the force F2 on the cutting device 9, correspondingly transmitting electrical signals to the microcontroller 37 via the lines 40, 41.

Moreover, the outer cutter 16, 17 may include a skin sensor 42 or a speed sensor which likewise sends its electrical data to the microcontroller 37 via a line 43. Finally, a mode switch 44 may be provided on the shaver housing 2 which transmits its data to the microcontroller 37 via a line 45. Further sensors, such as a speed sensor 56, a position sensor 57 or a friction sensor 58, may be connected to the microcontroller 37 via current lines 71, 72, 73. They inform the microcontroller 37 of the current shaver conditions. Responsive to these conditions and the contact forces F1 and/or F2, the actuator arrangement 47 and hence the cutter head 7 are brought into the proper position for such data.

The microcontroller 37 is furthermore connected via a line 46 to an electrically powered actuator arrangement 47 which is coupled to the drive shaft 33 of FIG. 2. Signals delivered from the microcontroller 37 via the line 46 are passed to the actuator arrangement 47 which then in turn pivots the cutter head 7 about the fulcrum 31 a greater or lesser amount in response to the magnitude and length of the signals. The actuator arrangement 47 also includes a servo position sensor 48 which determines each position of the actuator arrangement 47 and sends this electrical data to the microcontroller 37 via the line 49. The servo position sensor 48 is connected to the servo drive or the actuator arrangement 47 via a line 50.

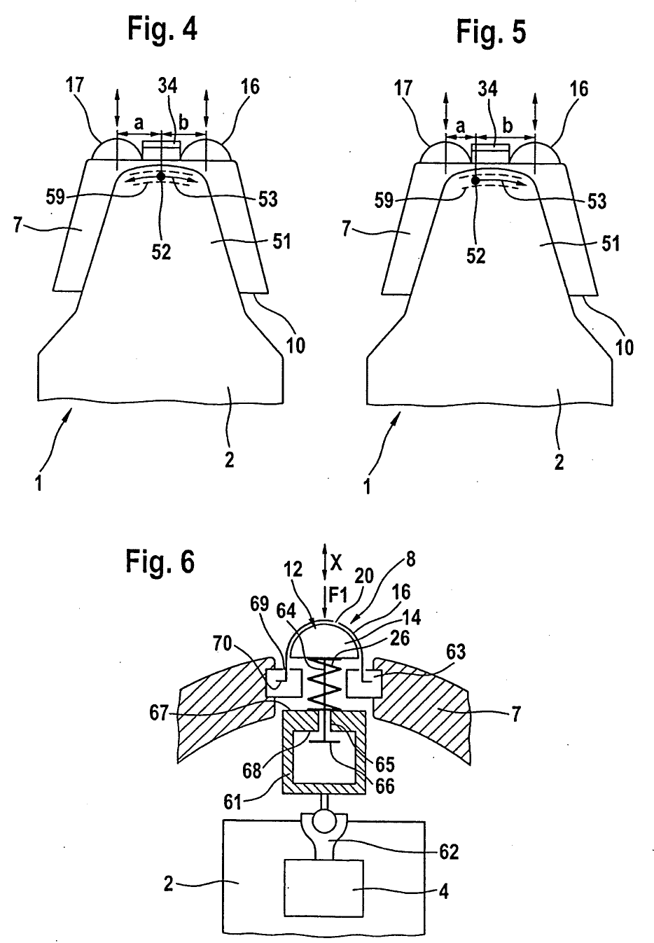

FIGS. 4 and 5 are schematic representations of the upper section of a shaver 1 on an enlarged scale in a side view. Extending on the shaver housing 2 upwardly on either side are arms 51 (the second arm cannot be seen in the drawing) which are connected to each other via a fulcrum 52. Here too, both the fulcrum 52 and the cutter head 7 extend perpendicularly into the plane of projection. The cutter head 7 is pivotal around the fulcrum 52 clockwise and counterclockwise on the one hand, and movable sideways from left to right and right to left in accordance with the direction of arrows 53 within a groove 59 (shown in broken lines) provided on the cutter head on the other hand. The sideways movement of cutter head 7 in accordance with the direction of arrows 53 produces a change in the distance a and b which is measured from the center of the outer cutter 16 and 17 to the fulcrum 52.

According to FIG. 5, the distance b was increased by the amount of leftward displacement of the fulcrum 52 relative to the cutter head 7, whereas the distance a was reduced by this amount. As a result, the torque acting on the cutter head 7 changes too, so that the cutter head 7 turns earlier in clockwise direction than is the case with the cutter head 7 in the position of FIG. 4, while the applied forces F1 and F2 are equal.

The mode of operation of the shaver 1 of FIG. 1 is as follows:

After the shaver 1 is switched on with the on/off switch 5, current is supplied to the electric motor 4 from the rechargeable battery 3 or some other electrical power source. Through the mechanical transmission device 28 the electric motor 4 sets the cutter blocks 12, 13 in an oscillatory reciprocating motion extending in the longitudinal direction of the under and outer cutters 12, 13 and 16, 17, respectively, with the outer cutters 16, 17 being substantially stationary in the housing portion 10, 11. As this occurs, the blades 14, 15 sweep across the apertures 20, 21 formed in the outer cutters 16, 17, so that hairs entering the apertures 20, 21 are captured by them and sheared or cut off. As the outer cutters 16, 17 slide along an operator's skin surface 29, irregularities of the skin surfaces 29 and the non-uniform contact pressure of the shaver 1 against the skin surface 29 produce different contact forces F1, F2. The under cutter 12 is urged against the outer cutter 16 with an initially higher spring force than is the case with the cutting device 9. In addition, the outer cutter 16 of the one cutting device 8 has a larger aperture geometry than the outer cutter 17 of the second cutting device 9. The term aperture geometry means that at least part of or all the apertures 20 have a diameter or cross-section greater than the apertures 21 of the other outer cutter 17.

Assuming now that like contact pressures are present on the cutting devices 8, 9, because of the different spring bias of springs 18, 19 the outer cutter 16 retracts at a pre-determined contact pressure of, for example, F1 equal to 3 Newton, and this with a spring constant C1 of, for example, 0.5 Newton per mm. The outer cutter 17 with the smaller apertures 21 retracts already at a lower contact pressure of, for example, F2 equal to 0 Newton, but then with a spring constant C2 greater than spring constant C1 of spring 18, for example, of C2 equal to 2 Newton per mm. At smaller contact pressures of up to 3 Newton, the outer cutter 16 with the larger apertures 20 performs a greater share of the shaving work, because the hairs are able to enter larger apertures 20 more readily than the smaller apertures 21 of the outer cutter 17.

Up to the predetermined value of 3 Newton, for example, the outer cutter 16 remains fully extended while the outer cutter 17 with the smaller apertures 21 has retracted already. However, when the shaver 1 is pressed against the skin surface 29 at an increased pressure, the contact pressure of the outer cutter 16 with the larger apertures 20 increases only insignificantly since this outer cutter 16, owing to its smaller spring constant C1, retracts in the presence of the same force increase more than the outer cutter 17 with the higher spring constant C2 which retracts at a contact force greater than zero, with the travel of retraction however decreasing with the force increasing. In this way, a more thorough shave with the outer cutter 16 having the larger apertures 20 is accomplished while at the same time the skin experiences a gentle treatment because it is not urged into the outer cutter 16 so deeply.

In the above description of the mode of operation of the shaver 1 of FIG. 1 a second cutting device 9 was mentioned. The second cutting device 9 may also be a pressure application device, preferably a pressure roller, which extends parallel to the cutting device 8. When pressed against the skin surface 29, the pressure roller acts precisely as if a second cutting device 9 were present there. The pressure roller even has the advantage that the skin surface 29 produces lower friction forces during shaving, however this system uses only a single cutting device 8 which results in a reduced cutting performance per reciprocating movement of the shaver 1.

The mode of operation of the shaver 1 according to FIGS. 2 and 3 is as follows: First it needs mentioning that the two cutting devices 8, 9 can be constructed essentially like the cutting devices 8, 9 of FIGS. 1 and 6, with the difference however that the springs 26, 27 may have like or unlike biasing forces and also like or unlike spring constants C1, C2. In the case of like spring constants C1, C2, the result is that in the presence of like contact forces both cutting devices 8, 9 retract equally with like forces F1, F2. However, on account of the electrical control of the cutter head 7 by the actuator arrangement 47, unlike contact forces F1, F2 having an effect on the skin penetration depth are produced on the cutting devices 8, 9.

In a first embodiment, only the first cutting device 8 includes a contact pressure sensor 38 (FIG. 3) which measures the contact pressure of the skin surface 29 against the cutting device 8. Since the outer cutters 16, 17 are constructed as very thin shaving foils, it is difficult to measure the penetration depth of the skin surface into the apertures 20, 21 directly. For this reason, a force sensor 38 is used whose electrical measurement values are a measure of the skin penetration depth.

According to FIG. 3, the value measured on the force sensor 38 is delivered to the microcontroller 37 via the line 40. If the contact force F1 is too high, the microcontroller 37 sends a signal to the electrically powered actuator arrangement 47 which pivots the drive shaft 33, the drive belt 32 and hence the cutter head 7 clockwise about the fulcrum 31, so that the cutting device 9 experiences a higher contact force F2, which means that the contact force F1 is reduced. This reduction is measured in turn by the contact pressure sensor 38 which issues a signal to the microcontroller 37 which stops the actuator arrangement 47. When the contact force F1 drops below a predetermined magnitude, of which the microcontroller 37 is informed by the contact pressure sensor 38, the actuator arrangement 47 is set in operation, and the cutter head 7 is pivoted counterclockwise about the fulcrum 31 until the contact force F1 has again increased to a predetermined magnitude. In this way, a comparatively constant force application of the two cutting devices 8, 9 is achieved. In the process, the actuator arrangement 47 moves of course so rapidly that the forces F1 and F2 adapt themselves to the instantaneous shaving condition within fractions of a second.

In another embodiment, the cutting device 8 and the supporting element 9 may each include a contact pressure sensor 38, 39, so that the microcontroller 37 compares both values and controls the actuator arrangement 47 in accordance with an evaluation table such that the contact forces F1, F2 acting upon the devices 8, 9 are distributed to both systems optimally. When the applied force is too high, it is of course the supporting element 9 which takes the major share of the load for gentle treatment of the skin on the cutting device 8.

In cases where the cutter head 7 includes two cutting devices 8, 9 of which the apertures 20 of the one outer cutter 16 are larger in cross-section than the apertures 21 in the other outer cutter 17, the distribution of the contact forces to the two shaving systems can be varied to the effect that up to a contact force F1 (smaller than 3 Newton) this force is essentially directed to the outer cutter 16 with the larger apertures 20. When the user applies an increased contact pressure, the additional force is absorbed by the outer cutters 16, 17 in proportion to the spring constants. For this purpose, the microcontroller 37 receives the data issued by the contact pressure sensors 38, 39, performs an evaluation and correspondingly controls the actuator arrangement 47 and hence the cutter head 7.

As a further feature, the shaver 1 may also be equipped with an electrically powered skin sensor 42. The skin sensor 42 measures the torque which acts on the cutter head 7 pivotal about the fulcrum 31. The torque is converted by a servo sensor 48 into electrical values which are supplied to the microcontroller 37. On the basis of this data and the data from the contact pressure sensors 38, 39, the microcontroller 37 can determine or calculate a value and transmit it to the actuator arrangement 47 which in turn pivots the cutter head 7 accordingly a greater or lesser amount in one direction of rotation in order to cause the contact forces F1, F2 to adopt predetermined permissible values. The servo current necessary on the actuator arrangement 47 to hold the cutter head 7 in a predetermined position is therefore a measure of the skin friction. In the presence of a major skin friction, the cutter head is therefore pivoted such that the contact force F1 acting on the outer cutter 16 with the larger apertures 20 is reduced. Of course, the skin friction can also be determined by means of a strain gage which detects, for example, the amount of sag on the suspension of the shaving head or the elongation of a very thin shaving foil 16, 17. Also these values can be fed to the microcontroller 37 which then processes and compares them and instructs the actuator arrangement 47 to bring the cutter head 7 into the proper position.

The shaver 1 may also be provided with a mode switch 44 which, depending on its setting, informs the microcontroller 37 via the line 45 of various requirements as, for example, “very sensitive skin” in a first setting, “sensitive skin” in a second setting or “normal skin” in a third setting. These settings could also be termed “soft, aggressive or fast”. In accordance with these settings, the microcontroller 37 controls the actuator arrangement 47 such that the cutter head 7 adopts a position in which the cutting device 8 can absorb a greater or lesser amount of the contact force F1.

Furthermore, the shaver 1 may be connected to a speed sensor 56, a position sensor 57 and/or a moisture sensor 58 via the lines 71, 72 and 73. To measure the shaver speed, the speed sensor 56 used may be an optical sensor constructed in the same way as the optical sensor of a computer mouse. Since at very low speeds the skin surface can penetrate into the apertures 20, 21 more deeply, the cutter head 7 in its basic setting is pivoted by a predetermined fixed amount to reduce the contact force generally by a fixed amount on the outer cutter 16 with the larger apertures 20. To accomplish this, the microcontroller 37 controls the actuator arrangement 47 and hence the cutter head 7 correspondingly.

A position sensor 57 may be arranged in the shaver 1 as a further sensor which is able to determine whether the shaving operation takes place, for example, on the neck—where a vertical position of the shaver 1 is appropriate—or on the cheek—where a horizontal position of the shaver is appropriate. Since the skin on the neck is more elastic or more sensitive than on the cheek, the cutter head 7 is then pivoted such that the contact force F1 of the outer cutter 16 with the larger apertures 20 is reduced.

Finally, a moisture sensor 56 measuring the moisture on the skin surface 29 may be provided on the shaver 1. The skin moisture can be measured, for example, by measuring the electric resistance between the two outer cutters 16, 17. Considering that moist skin is more elastic than dry skin and therefore penetrates more deeply into the apertures 20, 21 of the outer cutters 16, 17, the cutter head 7 is pivoted in this case so that the contact force F1 of the outer cutter 16 with the larger apertures 20 is reduced.

The mode of operation of the shaver 1 of FIGS. 4 and 5 is as follows:

When the fulcrum 52 lies centrally relative to the cutter head 7, i.e., the distances a and b are equal, the cutter head 7 remains stationary in an approximately horizontal position, as shown in FIG. 4, but only if the contact forces F1, F2 are also equal. To make the distance b greater than the distance a, the fulcrum 52 of FIG. 5 on the cutter head 7 is shifted to the left in the groove 59. By means of fasteners, the fulcrum 52 is fixed in place in the pivot head 7 to provide the latter with a fixed reference point relative to the arms. When now the cutter head 7 is exposed to like contact forces F1, F2, it pivots clockwise about the fulcrum 52 so that the outer cutter 17 has to take a larger share of the contact force F2 whilst the outer cutter 16 is relieved of this share of the load. As this occurs, the cutting devices 8, 9 retract in the direction of movement X, Y in dependence upon the spring forces. In this way, a shave can be performed which is more on the hard or more on the soft side.

The mode of operation of the cutting device of FIG. 6 is as follows:

First it should be mentioned however that the cutting device 8 shown in this Figure could be duplicated on a cutter head 7, as is also shown in FIG. 1, and that the mode of operation of both cutting devices 8, 9 also corresponds to the mode of operation of FIG. 1, so that this will not be referred to again to avoid duplicate description. Therefore, only the mode of function of the embodiment of the cutting device 8 shown in FIG. 6 and differing from FIG. 1 will be explained in the following.

When a contact force F1 acts on the outer cutter 16, the outer cutter 16 is displaced downwardly in the direction X, urging the cutter block 12 downwardly against the bias of the spring 26 and causing the enlarged portion 66 to lift itself clear of the stop 68 of the base 61. As this occurs, the outer cutter 16 is guided in the guiding device 69 of the removable frame 63. Although in FIG. 6 the bore 65 shows a substantial amount of clearance, this is not so in practice since the connection between the drive shaft 62 and the cutter block 12 needs to be rigid to ensure that the oscillatory motions are transmitted from the drive shaft 62 to the under cutters 12, 13 without loss of energy.

As soon as the contact force F1 diminishes, the spring 26 urges the under cutter 12 and with it also the outer cutter 16 upwardly. Outer cutter 16 and under cutter 12 are as a rule always in flush relative engagement to ensure at all times an optimum shearing motion and hence an optimum cutting pressure on the apertures 20.

What is claimed is:

1. An electrically operated shaver comprising:
an electric drive;
a shaver housing; and
a cutter head arranged on the shaver housing, the cutter head comprising
a support; and
a cutter assembly adjacent the support, the cutter comprising:
an outer cutter defining apertures for accepting hairs; and
an under cutter,
wherein:
the outer cutter and the under cutter are movable relative to each other by the electric drive, such that hairs entering the apertures are cut off by the cutter assembly,
the support and the cutter assembly are each engaged by a user's skin surface during a shaving operation in which each bears a respective skin contact load, and
the cutter head is configured to alter a skin contact force distribution between the cutter assembly and the support.

2. The shaver according to claim 1, wherein both the cutter assembly and the support are mounted in the cutter head for movement against the force of a spring.

3. The shaver according to claim 1, comprising a first spring operatively bearing against the cutter assembly and a second spring operatively bearing against the support, wherein the spring preload of the first spring is greater than the spring preload of the second spring.

4. The shaver according to claim 3, wherein the spring constant of the second spring is greater than the spring constant of the first spring.

5. The shaver according to claim 4, wherein the cutter assembly is retractable at a contact force of 3 Newtons when a spring constant of the first spring is 0.5 Newtons per mm, and the support is retractable at a contact force of less than 3 Newtons when a spring constant of the second spring is 2 Newtons per mm.

6. The shaver according to claim 5, wherein the support is retractable at a contact force of 0 Newtons.

7. The shaver according to claim 1, further comprising a first spring operatively bearing against the cutter assembly and a second spring operatively bearing against the support, wherein the support comprises a second cutter assembly, the second cutter assembly comprising:
a second outer cutter defining apertures for accepting hairs; and
a cutter block comprising blades biased into engagement with the second outer cutter,
wherein:
the cutter block configured to retract against the force of the second spring when the second outer cutter is depressed,
the outer cutter has a larger aperture geometry than the second outer cutter, and
the cutter assembly has a higher spring preload than the second cutter assembly.

8. The shaver according to claim 1, wherein:
the support comprises a second cutter assembly,
the cutter head comprises at least a third cutter assembly,
each cutter assembly defines apertures of a given geometry, and
each cutter assembly of a pair with like aperture geometry is arranged in an adjacent relationship with the other cutter assembly of the pair.

9. The shaver according to claim 1, wherein:
the shaver housing comprises a fulcrum that extends parallel to the longitudinal direction of the outer cutter and the under cutter and lies below a cutting plane obtained when the outer cutter is placed against the skin surface during shaving, and
the cutter head is pivotable about the fulcrum.

10. The shaver according to claim 9, wherein the fulcrum is displaceable sideways in a groove defined by the cutter head.

11. The shaver according to claim 10, wherein the ratio of the contact force acting on the outer cutter of the cutter assembly to the contact force acting on the under cutter of the cutter assembly is approximately equal to the reciprocal of the ratio of the distance of the outer cutter to the fulcrum to the distance of the under cutter to the fulcrum.

12. The shaver according to claim 1, further comprising:
a sensor operatively coupled to one or both of the cutter head and the support;
a fulcrum in the shaver housing, the fulcrum extending parallel to the longitudinal direction of the outer cutter and the under cutter;
an electrically actuatable actuator arranged to pivot the cutter head about the fulcrum; and
a microcontroller configured to control the actuator in response to the values detected by the sensor.

13. The shaver according to claim 12, further comprising a coupler arranged to couple the actuator to the cutter head, wherein:
the cutter head further comprises a motor for driving the cutter assembly, and
the actuator is arranged outside the cutter head on the shaver.

14. The shaver according to claim 12, wherein the sensor comprises a force sensor responsive to skin contact force on the cutter assembly.

15. The shaver according to claim 14, wherein:
the force sensor comprises a magnet mounted on the cutter assembly and a Hall probe mounted on the cutter head,
the Hall probe provides an electrical signal indicative of a magnitude of skin contact force on the cutter assembly.

16. The shaver according to claim 12, wherein the support comprises a second cutter assembly, the second cutter assembly comprising:
a second outer cutter defining apertures for accepting hairs; and
a cutter block comprising blades biased into engagement with the second outer cutter, wherein:
the cutter block is configured to retract against the force of the second spring when the second outer cutter is depressed,
the outer cutter has a larger aperture geometry than the second outer cutter, and
the cutter assembly has a higher spring preload than the second cutter assembly.

17. The shaver according to claim 12, wherein:
the support comprises a second cutter assembly,
the cutter head comprises at least a third cutter assembly,
each cutter assembly defines apertures of a given geometry, and
each cutter assembly of a pair with like aperture geometry is arranged in an adjacent relationship with the other cutter assembly of the pair.

18. The shaver according to claim 12, wherein the fulcrum is displaceable sideways on the cutter head.

19. The shaver according to claim 12, wherein:
the cutter head further comprises an additional sensor responsive to shaver speed,
the additional sensor is electrically connected to the microcontroller, and
the microcontroller controls the actuator and the cutter head as a function of shaver speed as indicated by the additional sensor.

20. The shaver according to claim 19, wherein the additional sensor is an optical sensor.

21. The shaver according to claim 12, further comprising an additional sensor responsive to moisture of the skin and electrically connected to the microcontroller, wherein the microcontroller controls the actuator and the cutter head as a function of skin moisture as indicated by the additional sensor.

22. The shaver according to claim 12, wherein the support comprises a second cutter, the second cutter comprising:
a second outer cutter defining apertures for accepting hairs; and
a cutter block comprising blades biased into engagement with the second outer cutter,
wherein the additional sensor is a measuring device responsive to an electrical resistance between the outer cutter and the second outer cutter.

23. The shaver according to claim 12, further comprising an additional sensor responsive to position of the outer cutter and electrically connected to the microcontroller, wherein the microcontroller controls the actuator and the cutter head as a function of position of the outer cutter as indicated by the additional sensor.

24. The shaver according to claim 12, wherein the outer cutter comprises an additional sensor responsive to friction between the skin and the outer cutter, the additional sensor is electrically connected to the microcontroller, and the microcontroller controls the actuator and the cutter head as a function of friction between the outer cutter and the skin as indicated by the additional sensor.

25. The shaver according to claim 24, wherein the additional sensor comprises a strain gage.

26. A method for controlling the distribution of skin contact forces acting on a cutter head of an electrically operated shaver, the method comprising:
selecting a predetermined value for a skin contact force on a cutter assembly of the cutter head;
assessing a parameter indicative of the skin contact force on the cutter assembly; and
activating an actuator of the shaver when the assessed parameter is indicative of a skin contact force different from the predetermined value.

27. The method according to claim 26, further comprising controlling the actuator by a microcontroller as a function of an electrical signal indicative of a magnitude of the skin contact force on the cutter assembly.

28. The method according to claim 27, further comprising:
sensing a speed of the shaver with a speed sensor that sends electrical signals to the microcontroller; and
controlling the actuator and the cutter head with the microcontroller as a function of the sensed speed.

29. The method according to claim 27, further comprising:
sensing skin moisture with a moisture sensor that sends electrical signals to the microcontroller; and
controlling the actuator and the cutter head with the microcontroller as a function of the sensed moisture.

30. The method according to claim 27, further comprising:
sensing a position of the shaver with a sensor that sends electrical signals to the microcontroller; and
controlling the actuator and the cutter head with the microcontroller as a function of the sensed position.

31. The method according to claim 26, wherein the cutter head comprises a support formed by a rotary supporting roller that extends parallel to a longitudinal direction of the cutter assembly and forms a cutting plane with the cutter assembly.

32. The method according to claim 26, wherein the cutter head comprises an additional cutter assembly.

33. The method according to claim 32, wherein the cutter assembly comprises a first outer cutter defining apertures, and the additional cutter assembly comprises:
a second outer cutter defining apertures; and
a cutter block comprising blades biased into engagement with the second outer cutter,
wherein the cutter block retracts against the force of a spring when the second outer cutter is depressed, and
the first outer cutter has a larger aperture geometry than the second outer cutter.

34. The method according to claim 33, wherein the cutter assembly has a higher spring preload than the additional cutter assembly.

35. The method according to claim 26, wherein the cutter head comprises three cutter assemblies, and each cutter assembly of a pair with like aperture geometry is arranged in an adjacent relationship with the other cutter assembly of the pair.

36. The method according to claim 26, wherein the cutter head is pivotable about a fulcrum, and the fulcrum is sideways displaceable on the cutter head.

37. An electrically operated shaver comprising:
an electric drive;
a shaver housing;
a cutter head arranged on the shaver housing, the cutter head comprising
a support; and
a cutter assembly adjacent the support, the cutter comprising:
an outer cutter defining apertures for accepting hairs; and
an under cutter,
wherein the support and the cutter assembly are each engaged by a user's skin surface during a shaving operation in which each bears a respective skin contact load, and the outer cutter and the under cutter are movable relative to each other by the electric drive, such that hairs entering the apertures are cut off by the cutter assembly, and
means for altering a skin contact force distribution between the cutter assembly and the support.
